(19) United States
(12) Patent Application Publication
(10) Pub. No.: US 2006/0071566 A1
(43) Pub. Date: Apr. 6, 2006

(54) Motor

(76) Inventor: Sung Wook Ha, Gyeongsangnam-do (KR)

Correspondence Address: FISH & RICHARDSON P.C., P.O. BOX 1022, MINNEAPOLIS, MN, 55440-1022, US

(21) Appl. No.: 11/242,122

(22) Filed: Oct. 4, 2005

(30) Foreign Application Priority Data
Oct. 5, 2004 (KR) 2004-0079144

(51) Int. Cl. H02K 5/00

(52) U.S. Cl. 310/89

(57) ABSTRACT

A motor includes a stator including a rim portion and a central portion, with the rim portion including through holes and the center portion including a through opening. A rotor installed in the through opening of the stator includes at least one rotational shaft extending from a rotating center of the rotor, such that the rotor rotating as a result of electrical interaction between the stator and the rotor. A first bracket of the motor includes fastening bars that pass through the through holes of the stator, and include elastically deformable elastic fingers. A second bracket of the motor includes fastening holes formed in positions corresponding to the fastening bars of the first bracket and engaging the elastic fingers of the fastening bars.

### BACKGROUND

This description relates to a motor for generating a rotational force using electrical energy.

FIG. 1 is a sectional view showing a disassembled state of a motor. As shown in the figure, the motor comprises a stator 1 and a rotor 2 penetrating the center of the stator 1. A rotational shaft 3 of the rotor 2 passes through first and second brackets 4 and 5 and thus is rotatably supported therein. The stator 1 is joined to the first and second brackets 4 and 5.

To this end, a plurality of through holes 1a, through which screws 6 for fastening the first and second brackets 4 and 5 pass, are formed around a rim portion of the stator 1. In addition, the stator 1 is formed with a through opening 1b through which the rotor 2 passes.

The rotor 2 is installed in the opening 1b of the stator 1 in a state where a gap between an outer diameter of the rotor 2 and an inner diameter of the stator 1 is kept at a predetermined interval. Thus, the rotor 2 rotates about the center of the rotational shafts 3 by electrical interaction between the stator 1 and the rotor 2.

The first bracket 4 is formed with fastening holes 4a, through which the screws 6 pass, at positions corresponding to the through holes 1a. A through hole 4b, through which an end of the rotational shaft 3 passes, is formed in the center of the first bracket.

The second bracket 5 is formed with fastening holes 5a at positions corresponding to the fastening holes 4a of the first bracket 4. The screws 6 which sequentially passed through the fastening holes 4a of the first bracket 4 and the through holes 1a of the stator 1 are fastened to the fastening holes 5a. In addition, the second bracket 5 is formed with a through hole 5b, through which the other one of the rotational shafts 3.

In such a conventional motor, the screws 6 sequentially pass through the fastening holes 4a of the first bracket 4 and the through holes 1a of the stator 1 and are then fastened to the fastening holes 5a of the second bracket 5, so that the first and second brackets 4 and 5 are fastened to each other.

### SUMMARY

In one general aspect, a motor includes a stator including a rim portion and a central portion, with the rim portion including through holes and the center portion including a through opening. A rotor installed in the through opening of the stator includes at least one rotational shaft extending from a rotating center of the rotor, such that the rotor rotating as a result of electrical interaction between the stator and the rotor. A first bracket of the motor includes fastening bars that pass through the through holes of the stator, and include elastically deformable elastic fingers. A second bracket of the motor includes fastening holes formed in positions corresponding to the fastening bars of the first bracket and engaging the elastic fingers of the fastening bars.

Implementations may include one or more of the following features. For example, at least one of the first and second brackets may include a through hole through which the rotational shaft of the rotor extends. When the rotor includes two rotational shafts, both of the first and second brackets may include through holes through which the rotational shafts of the rotor extend.

First and second seats may be formed on opposite ends of a through hole of the stator, and each of the seats may have an inner diameter larger than that of the through hole. A first seating protrusion may be formed on a proximal end of a fastening bar of the first bracket, with the first seating protrusion having an outer diameter corresponding to the inner diameter of the first seat of the stator. A second seating protrusion may be formed on an inlet of a fastening hole of the second bracket, with the second seating protrusion having an outer diameter corresponding to the inner diameter of the second seat of the stator. The seating protrusions of the first and second brackets may be tightly placed in the seats of the stator when the first and second brackets are fastened to each other.

At least a pair of the elastic fingers may be provided on a distal end of a fastening bar, with the elastic fingers being spaced apart from each other in a direction perpendicular to a direction in which the fastening bar is inserted into the fastening hole. A catching protrusion may be provided on a distal end of each of the elastic fingers such that the catching protrusion engages a catching step in the fastening hole and is fastened to the second bracket when the fastening bar is fastened to the fastening hole. An inclined guide surface may be formed on an outer surface of each of the catching protrusions to be inclined at a predetermined angle and to taper toward a distal end of the catching protrusion, whereby the inclined guide surface allows the fastening bar to be easily fastened to the fastening hole. Each of the fastening holes of the second bracket may have a larger inner diameter portion and a smaller inner diameter portion, and the catching step may be formed at a portion where the inner diameter is changed.

The first and second brackets may be made of synthetic resin.

Such a motor may be securely assembled and may be used in a wet environment. Implementations may include a reduced number of parts relative to motors that do not employ fastening bars. Through use of the fastening bars and their associated elastic fingers, implementations of the motor may be assembled without requiring the use of screwdrivers or other tools. Moreover, in contrast to a connection provided by screws, the connection provided by fastening bars and fastening fingers is not subject to loosening, and associated noise or damage that may occur, as a result of vibrations caused by operation of the motor.

Other features and advantages will be apparent from the following description, including the drawings, and the claims.

### BRIEF DESCRIPTION OF THE DRAWINGS

FIG. 1 is a sectional view showing a disassembled state of a prior art motor.

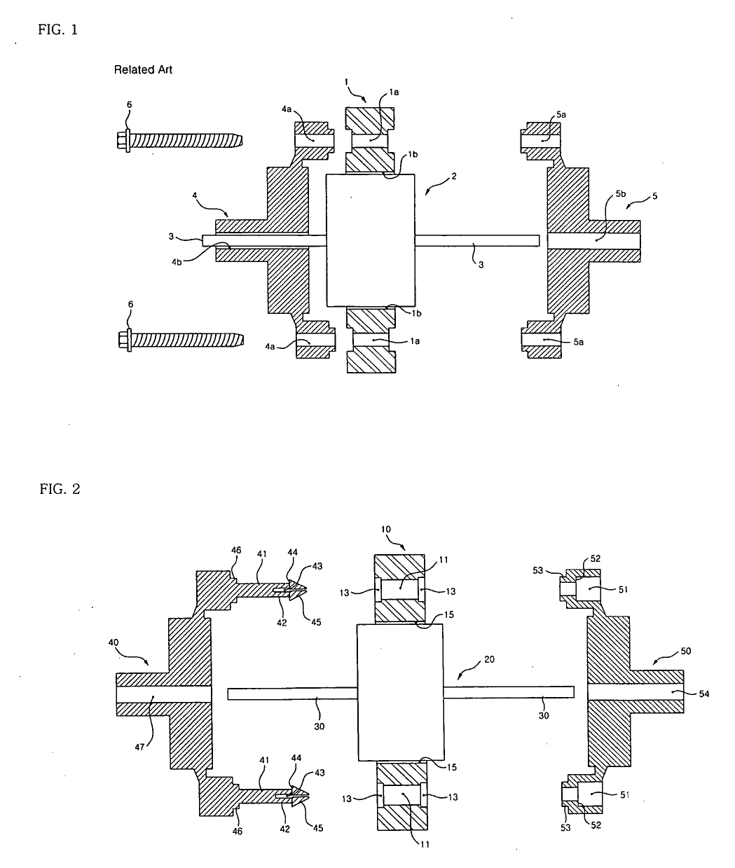

FIG. 2 is a sectional view showing a disassembled state of a motor. FIG. 3 is a sectional view showing an assembled state of the motor of FIG. 2.

### DETAILED DESCRIPTION

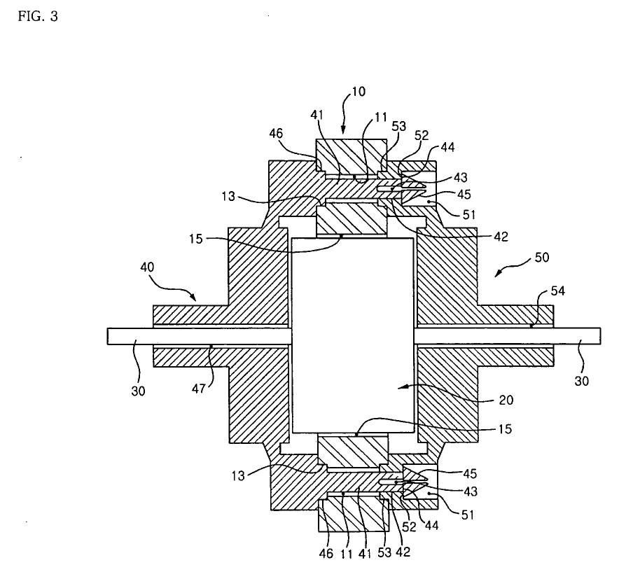

Referring to FIGS. 2 and 3, through holes 11 are formed around a rim portion of a stator 10. The through holes 11 extend through the stator 10 in a direction in which a rotational shaft 30 of a rotor 20 extends. Fastening bars 41 formed on a first bracket 40 pass through the through holes 11. Seats 13 are formed in opposite ends of each of the through holes 11. The seats 13 are formed around inlets of the through holes 11. An inner diameter of a seat 13 is larger than that of the through hole 11.

Further, the stator 10 is formed with a through opening 15 through which the rotor 20 passes. The through opening 15 is extends through the stator 10 in a direction in which the through holes 11 extend. In general, the center of the through opening 15 coincides with the center of the stator 10.

The rotor 20 is placed in the through opening 15 of the stator 10. Rotational shafts 30 are provided at the rotational center of the rotor 20. The rotational shafts 30 extend from opposite sides of the rotor 20. In some implementations, only a single rotational shaft 30 is provided. The rotor 20 rotates about the center of the rotational shafts 30 by electrical interaction between the stator 10 and the rotor 20. To this end, a gap between an outer surface of the rotor 20 and an inner surface of the through opening 15 is maintained at a generally constant size.

In order to rotatably support the rotor 20 in the stator 10, first and second brackets 40 and 50 are provided. In certain implementations, particularly implementations in which the motor is to be used in a wet place, the first and second brackets 40 and 50 may be made of synthetic resin. Other implementations, particularly those in which the motor does not need to be used in a wet place, may employ materials other than synthetic resin for the brackets.

The first bracket 40 includes fastening bars 41 that extend from the first bracket. The fastening bars 41 pass through the through holes 11 of the stator 10 and are fastened to fastening holes 51 of the second bracket 50. Thus, the fastening bars 41 are formed at positions corresponding to the through holes 11. That is, the fastening bars 41 protrude in one direction from the positions on a rim portion of the first bracket 40.

At least two elastic fingers 42 are formed at a distal end of each fastening bar 41. The elastic fingers can be elastically deformed in a direction perpendicular to the direction in which the fastening bar 41 extends into a fastening hole 51. At least two of the elastic fingers 42 are formed to face each other across a space that is referred to as an elastic slot 43.

Each of the elastic fingers 42 is formed with a catching protrusion 44 at a distal end thereof. The catching protrusions 44 engage corresponding catching steps 52 in the fastening holes 51 when the fastening bars 41 are fastened to the fastening holes 51 of the second bracket 50.

An inclined guide surface 45 is formed on an outer surface of each of the catching protrusions 44. The inclined guide surface 45 is formed to be inclined at a predetermined angle such that the catching protrusion 44 has a relatively smaller diameter at its distal end and a relatively larger diameter at its proximal end. The inclined guide surfaces 45 allows the fastening bars 41 to be easily inserted into the through holes 11 and the fastening holes 51, and thus assist the elastic fingers 42 in being elastically deformed.

In addition, seating protrusions 46 are formed on portions of the first bracket 40 corresponding to the proximal ends of the fastening bars 41. Each of the seating protrusions 46 is formed to have substantially the same outer diameter as that of a seat 13 and is inserted into a seat 13 when the motor is assembled.

A through hole 47, through which one of the rotational shafts 30 passes, extends through the center of the first bracket 40. The through hole 47 is designed so that the rotational shaft 30 is rotatably supported therein.

The second bracket 50 is provided with the fastening holes 51 to which the fastening bars 41 are fastened. The fastening holes 51 are formed at positions corresponding to the fastening bars 41. As noted above, the fastening holes 51 include catching steps 52 formed on the interior of the fastening holes 51. When the fastening bars 41 are fastened to the fastening holes 51, the catching protrusions 44 engage with the catching steps 52. Each of the fastening holes 51 has a larger inner diameter portion and a smaller inner diameter portion, So that the catching step 52 is formed at a portion where the inner diameter is changed.

In addition, an inlet of each fastening hole 51 of the second bracket 50 is formed with a seating protrusion 53. The seating protrusions 53 engage the seats 13 of the stator 10 when the second bracket 50 is fastened to the stator 10. Thus, the seating protrusion 53 has an outer diameter that matches the inner diameter of the seat 13.

A through hole 54, through which the other one of the rotational shafts 30 passes, extends through the center of the second bracket 50. The through hole 54 is designed so that the rotational shaft 30 is rotatably supported therein.

The operation of the motor now will be described in detail.

First, a process of assembling the motor will be described. Initially, the rotor 20 is positioned such that it can be placed within the through opening 15 of the stator 10. In such a state, by moving the second bracket 50 toward the rotor or stator, the seating protrusions 53 of the second bracket 50 are placed on the seats 13 of the stator 10. At this time, one of the rotational shafts 30 of the rotor 20 passes through the through hole 54 of the second bracket 50.

Next, the fastening bars 41 of the first bracket 40 are inserted into the through holes 11 of the stator 10, and then are fastened to the fastening holes 51 of the second bracket 50. At this time, the seating protrusions 46 of the first bracket 40 are placed on the seats 13 of the stator 10, and the other one of the rotational shafts 30 passes through the through hole 47 of the first bracket 40.

Here, a process of fastening the fastening bars 41 to the fastening holes 51 of the second bracket 50 will be described. The elastic fingers 42 formed at the distal ends of the fastening bars 41 are inserted into the fastening holes 51 and first pass through the smaller inner diameter portions of the fastening holes 51. At this time, the elastic slots 43 permit the elastic fingers 42 to be elastically deformed and thus to be brought into close contact with each other. Thus, the elastic fingers 42 and their catching protrusions 44 can pass through the smaller inner diameter portions of the fastening holes 51.

Once the catching protrusions 44 pass through the smaller inner diameter portions of the fastening holes 51, the elastic fingers 42 shift back to their original state such that the catching protrusions 44 engage the catching steps 52 in the fastening holes 51.

Next, the operation of the assembled motor will be explained.

When the motor is energized, the rotor 20 rotates by electrical interaction between the stator 10 and the rotor 20. Thus, the rotational shafts 30 of the rotor 20 rotate. Since the rotational shafts 30 are rotatably supported in the through holes 47 and 54 of, respectively, the first and second brackets 40 and 50, the rotor 20 also rotates with respect to the stator 10. The portions of the rotational shafts 30 that protrude outward from the brackets 40 and 50 are connected to transmit a rotational force to other elements.

As noted, the fastening bars formed on the first bracket are directly fastened to the fastening holes of the second bracket. Thus, since the additional parts for fastening the first and second brackets to each other are not needed, the motor may include a reduced number of parts and a correspondingly reduced manufacturing cost.

In addition, the fastening bars are directly fastened to the fastening holes without using additional tools when the first and second brackets are fastened to each other. Thus, since the motor brackets can be easily fastened to each other, there is another advantage in that the process of assembling and disassembling the motor is simplified, and thus, the efficiency of the process is also improved.

Further, since the catching protrusions of the fastening bars engage the catching steps of the fastening holes when the first bracket has been fastened to the second bracket, the first bracket cannot be removed from the second bracket without manipulating the elastic fingers 42. Thus, the fastened state of the first and second brackets is secure and will not be loosened even when the motor is used for a long time. Thus, the motor has high durability and operational reliability.

In addition, when the first and second brackets, as well as the fastening bars, are made of synthetic resin, the motor brackets and the fastening bars will not corrode even when the motor is used in a wet place. Therefore, higher reliability for the motor can be ensured.

Other implementations are within the scope of the following claims.

What is claimed is:

1. A motor, comprising:
a stator including a rim portion and a central portion, with the rim portion including through holes and the center portion including a through opening;
a rotor installed in the through opening of the stator and including at least one rotational shaft extending from a rotating center of the rotor, the rotor rotating as a result of electrical interaction between the stator and the rotor;
a first bracket including fastening bars that pass through the through holes of the stator, and include elastically deformable elastic fingers; and
a second bracket including fastening holes formed in positions corresponding to the fastening bars of the first bracket and engaging the elastic fingers of the fastening bars.

2. The motor as claimed in claim 1, wherein at least one of the first and second brackets includes a through hole through which the rotational shaft of the rotor extends.

3. The motor as claimed in claim 2, wherein the rotor includes two rotational shafts and both of the first and second brackets include through holes through which the rotational shafts of the rotor extend.

4. The motor as claimed in claim 1, wherein first and second seats are formed on opposite ends of a through hole of the stator, and each of the seats has an inner diameter larger than that of the through hole.

5. The motor as claimed in claim 4, wherein a first seating protrusion is formed on a proximal end of a fastening bar of the first bracket, the first seating protrusion having an outer diameter corresponding to the inner diameter of the first seat of the stator, and a second seating protrusion is formed on an inlet of a fastening hole of the second bracket, the second seating protrusion having an outer diameter corresponding to the inner diameter of the second seat of the stator, whereby the seating protrusions of the first and second brackets are tightly placed in the seats of the stator when the first and second brackets are fastened to each other.

6. The motor as claimed in claim 1, wherein at least a pair of the elastic fingers are provided on a distal end of a fastening bar, the elastic fingers being spaced apart from each other in a direction perpendicular to a direction in which the fastening bar is fastened into the fastening hole, and a catching protrusion is provided on a distal end of each of the elastic fingers, the catching protrusion engaging a catching step in the fastening hole and fastened to the second bracket when the fastening bar is fastened to the fastening hole.

7. The motor as claimed in claim 5, wherein an inclined guide surface is formed on an outer surface of each of the catching protrusions to be inclined at a predetermined angle and to taper toward a distal end of the catching protrusion, whereby the inclined guide surface allows the fastening bar to be easily fastened to the fastening hole.

8. The motor as claimed in claim 7, wherein each of the fastening holes of the second bracket has a larger inner diameter portion and a smaller inner diameter portion, and the catching step is formed at a portion where the inner diameter is changed.

9. The motor as claimed in claim 1, wherein the first and second brackets are made of synthetic resin.

10. A method of assembling a motor, the method comprising:
providing a stator including a rim portion and a central portion, with the rim portion including through holes and the center portion including a through opening;
installing a rotor that includes at least one rotational shaft in the through opening of the stator such that the rotor may rotate as a result of electrical interaction between the stator and the rotor;
assembling the stator and a first bracket having fastening bars that include elastically deformable elastic fingers such that the fastening bars pass through the through holes of the stator; and
securing a second bracket to the first bracket with the stator between the brackets, the second bracket including fastening holes formed in positions corresponding to the fastening bars of the first bracket that engage the elastic fingers of the fastening bars.

11. The method of claim 10, wherein assembling and securing the brackets comprises doing so such that the rotational shaft of the rotor extends through a through hole of one of the brackets.

12. The method of claim 10, wherein:
the rotor includes two rotational shafts, and
assembling and securing the brackets comprises doing so such that the rotational shafts of the rotor extend through through holes of the brackets.

13. The method of claim 10, wherein:
first and second seats are formed on opposite ends of a through hole of the stator;
a first seating protrusion is formed on a proximal end of a fastening bar of the first bracket;
a second seating protrusion is formed on an inlet of a fastening hole of the second bracket; and
assembling and securing the brackets comprises doing so such that the seating protrusions of the first and second brackets are tightly placed in the seats of the stator when the first and second brackets are secured to each other.

14. The method of claim 10, further comprising forming the first and second brackets from synthetic resin.
